(19) United States
(12) Patent Application Publication
(10) Pub. No.: US 2011/0225035 A1
(43) Pub. Date: Sep. 15, 2011

(54) Determining Supply and Demand Using Online Advertisements

(75) Inventors: Pritesh Patwa, Redmond, WA (US); Martin Markov, Redmond, WA (US)

(73) Assignee: MICROSOFT CORPORATION, Redmond, WA (US)

(21) Appl. No.: 12/709,856

(22) Filed: Mar. 9, 2010

(51) Int. Cl. G06Q 10/00; G06Q 30/00

(52) U.S. Cl. 705/14.41; 705/7.31

(57) ABSTRACT

Systems, methods, and computer media for determining supply of and demand for a category of product or service are provided. Demand for a category of good or service is determined by combining advertising performance information for online advertisements relating to the category of goods or services and Internet query information relating to the category of goods or services using a weighting scheme. Supply of the category of good or service is determined by combining online advertisement placement information, offline advertisement placement information, and offline sales location information relating to the category of good or service using a weighting scheme. A user may select to view supply, demand, or supply and demand for the category of good or service.

### BACKGROUND

Attempting to determine supply of a category of goods or services and demand for the category of goods or services is a task that has vexed merchants since the beginning of commerce. With population growth and increased globalization of marketplaces, the number and quantity of goods and services offered has grown and become more difficult to track and quantify. Additionally, shopping for goods and services is now frequently conducted online in addition to traditional “brick and mortar” stores.

### SUMMARY

Embodiments of the present invention relate to systems, methods, and computer media for determining supply and demand for a category of goods or services. Using the systems and methods described herein, demand for a category of goods or services can be determined by combining advertising performance information for online advertisements relating to the category of goods or services and Internet query information relating to the category of goods or services using a weighting scheme. Supply of the category of goods or services can be determined by combining online advertisement placement information, offline advertisement information, and offline sales location information relating to the category of goods or services using a weighting scheme. A user may select to view supply, demand, or supply and demand for a particular category of goods or services.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of a supply and demand determination system according to an embodiment of the present invention;

FIG. 3 is a flow chart of an exemplary method for determining demand for a category of goods or services;

FIG. 4 is a flow chart of an exemplary method for determining supply of a category of goods or services; and

FIG. 5 is a flow chart of an exemplary method for determining supply and/or demand for a category of goods or services.

### DETAILED DESCRIPTION

Embodiments of the present invention are described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” or “module” etc. might be used herein to connote different components of methods or systems employed, the terms should not be interpreted as implying any particular order among or between various steps herein disclosed unless and except when the order of individual steps is explicitly described.

Embodiments of the present invention provide systems, methods, and computer media for determining supply and demand. In accordance with embodiments of the present invention, a user selects a category of goods or services through a user interface and then selects whether to view supply, demand, or both supply and demand for the category of goods or services. The user might further narrow the inquiry by specifying a geographic region and/or demographic information. For example, a user may request to view demand for coffee in the Seattle area for females younger than 40 years of age.

Various indicators of demand, including online advertising performance information for advertisements related to a category of goods or services and online user Internet query information for queries associated with the category of goods or services, are considered and combined using a weighting scheme. Demand may then be displayed to the user on a map according to, for example, a relative scale in which areas of low, medium, or high demand are indicated.

Similarly, if the user selects to view supply of a category of goods or services, supply can be determined by combining various indicators of supply using a weighting scheme. As with demand, determination of supply can be limited to a particular geographic area and/or demographic. Supply indicators include online advertisement placement information for online advertisements related to the category of goods or services and offline information such as merchant listings or advertisements in telephone directories. Supply may also be displayed to the user on a map according to a relative scale.

In one embodiment, a method for determining demand for a category of goods or services is provided. Advertising performance information for a plurality of online advertisements relating to the category of goods or services is retrieved. The online advertisements are placed by a plurality of advertisers. Search query information for a plurality of user Internet queries relating to the category of goods or services is also retrieved. Demand is determined for the category of goods or services by combining the retrieved advertising performance information and the retrieved search query information using a weighting scheme.

In another embodiment, a method for determining supply of a category of goods or services is provided. Online advertisement placement information relating to the category of goods or services is retrieved for a plurality of online advertisers. Offline advertisement placement information and offline sales location information relating to the category of goods or services are retrieved for a plurality of entities. Supply of the category of goods or services is determined by combining the retrieved online and offline advertisement placement information and the offline sales location information using a weighting scheme.

In still another embodiment, a method for determining supply and/or demand for a category of goods or services is provided. A user interface allowing a user to select and view supply, demand, or supply and demand for the category of goods and services is presented to the user. Upon receiving a user selection to view supply or supply and demand, supply is determined. Supply is determined by retrieving online advertisement placement information relating to the category of goods or services for a first plurality of online advertisers; retrieving, for a plurality of entities, offline advertisement placement information and offline sales location information relating to the category of goods or services; and combining the retrieved online and offline advertisement placement information and offline sales location information using a weighting scheme. Upon receiving a user selection to view demand or supply and demand, demand is determined. Demand is determined by retrieving advertising performance information for a plurality of online advertisements relating to the category of goods or services and placed by a second plurality of advertisers; retrieving search query information for a plurality of user Internet queries relating to the category of goods or services; and combining the retrieved advertising performance information and the retrieved search query information using a weighting scheme. Supply and/or demand are then displayed to the user.

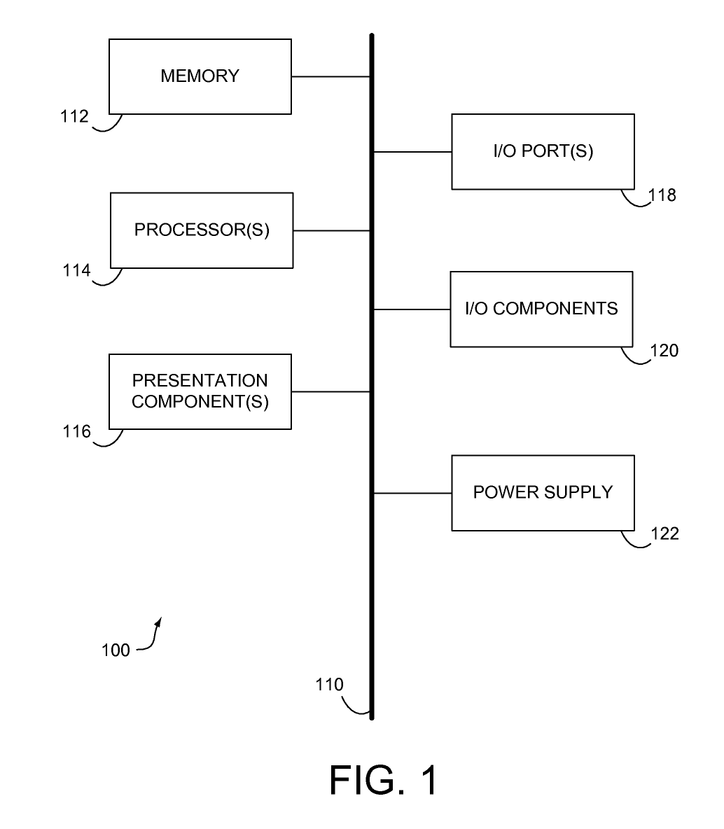

Having briefly described an overview of some embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of embodiments of the present invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the present invention may be practiced in a variety of system configurations, including hand-held devices, consumer electronics, general-purpose computers, more specialty computing devices, etc. Embodiments of the present invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

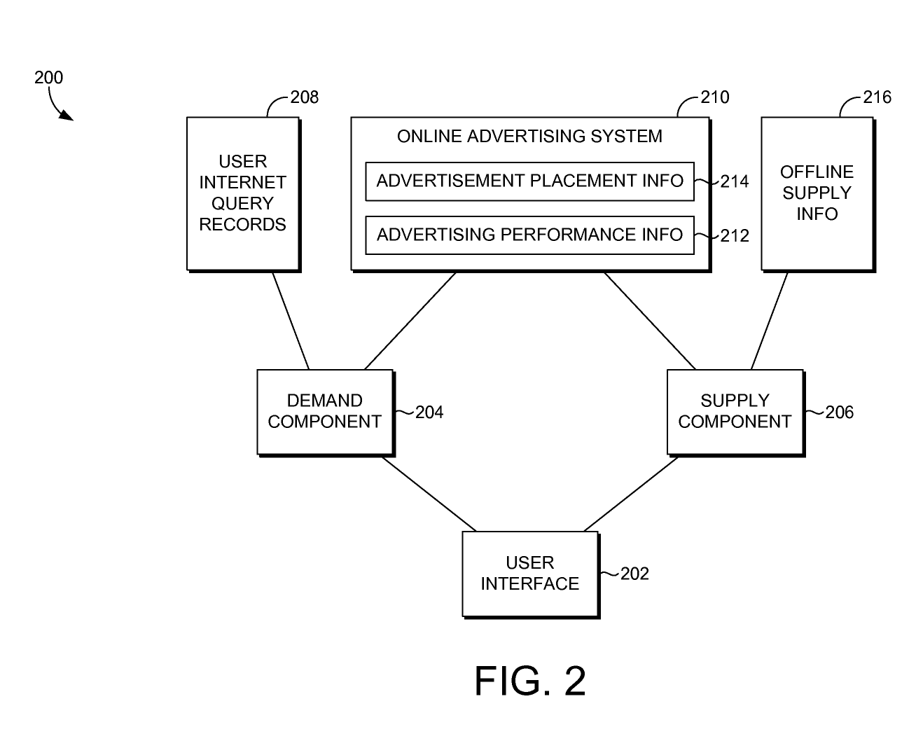

As discussed previously, embodiments of the present invention provide systems, methods, and computer media for determining supply and demand for a category of goods or services. Embodiments of the invention will be discussed in reference to FIGS. 2-5.

FIG. 2 illustrates a block diagram of a supply and demand determination system 200 according to an embodiment of the present invention. User interface 202 allows a user to view supply and/or demand for a particular category of goods or services according to user-selected criteria. “Category of goods or services” as used herein includes a specific good or service, group of goods or services, product or group of products, and brand or groups of brands. Demand component 204 and supply component 206 are in communication with user interface 202 and determine supply and/or demand as specified by a user through user interface 202. User interface 202 is discussed in greater detail below.

Demand component 204 accesses user Internet query records 208 and/or online advertising system 210 to gather information used in determining demand. User Internet query records 208 may contain information for user Internet searches relating to multiple categories of goods and services. Internet query records 208 may contain a variety of information related to each user search such as keywords searched, keyword category, requesting IP (Internet Protocol) address, location where the search was performed, search time and date, and age, gender, and other demographic data of the user who performed the search. Demographic data may be obtained through the use of Internet cookies or may be known because a user logged in to a search system account before performing the search. The location where a search was performed may be determined from the requesting IP address.

Internet query records 208 may be searchable by keyword, category, requesting IP address, or other criterion. In some embodiments, groups of related searches are combined into a single category. For example, searches for “coffee,” “coffee beans,” “gourmet coffee,” “coffee maker,” “coffee shop,” and “espresso” may all be grouped into one category. The one category may include subcategories such as “coffee” and “coffee accessories.” When a user selects through user interface 202 to view demand for a particular category of goods or services, the user may select from a pre-defined list of categories or demand component 204 or user interface 202 may convert the user-entered category to one or more search keywords, search phrases, or search groupings and retrieve the corresponding information from user Internet query records 208. User Internet query records 208 may be sorted according to one or more criteria in advance of retrieval or may be sorted on demand. User Internet query records 208 may be stored in a database on a server, group of servers, client computing device, computer-readable media or other location and may be continually updated to reflect recent user searches.

Online advertising system 210 contains advertising performance information 212 for online advertisements that have been placed by advertisers on web pages. Advertising performance information 212 includes the number of times an ad has been clicked on by users who have viewed the ad while it was placed on a web page (“ad clicks”) and the number of times a click has resulted in a purchase (“ad conversion”). In some embodiments, demand component 204 retrieves all of both ad click and ad conversion information. In other embodiments, only one of ad click and ad conversion information is retrieved. In still other embodiments, the number of times a particular online ad was displayed on a web page (“ad appearances”) is also retrieved.

Advertisements in online advertising system 210 are typically targeted to an audience. Advertisements may be targeted to a general audience or to a specific audience defined at least in part by one or more demographic criteria such as geographic location, age group, income, education level, and gender. When an online advertisement is placed on a web page, the online advertiser provides conditions for determining when the ad is displayed. In the case of advertisements targeted to a general audience, ads may be displayed whenever a particular web page is requested or whenever particular search keywords are received.

When advertisements are targeted to a specific audience, ads may be displayed only when the person requesting a web page or searching with particular search keywords meets pre-defined demographic criteria. For example, an advertiser may select to display a coffee ad if the user who has navigated to the web page where the ad will be displayed is a certain age and certain gender or if the requesting IP address indicates the user is located in a specific geographic location. Demographic information about users navigating to web pages may be known because a user is logged into a search system with a user account that includes a demographic profile. In some embodiments, online advertisements placed using online advertising system 210 are searchable, allowing demand component 204 to identify placed online advertisements that correspond to the user-selected category. Demand component 204 then retrieves advertising performance information 212, including ad clicks and ad conversion, about the identified ads. Advertising performance information 212 can include information for online ads targeted to general, specific, or general and specific audiences.

After gathering information from user Internet query records 208 and online advertising system 210, demand component 204 applies a weighting scheme to determine demand based on the gathered information. The weighting scheme may be selected to meet the particular preferences of the user. In some embodiments, ad conversion is weighted most importantly, followed by ad clicks, and user Internet queries are weighted least importantly. The applied weighting scheme may include statistical formulas. Demand may be determined as a numerical value or may be determined as a relative value, such as “high.”

Similarly, supply component 206 retrieves information for determining supply of a category of goods or services. Supply information includes advertisement placement information 214 from online advertising system 210 as well as offline supply information 216. Advertisement placement information 214 includes the number of online advertisements placed on web pages for a particular category of goods or services. As used herein, advertisements are considered to be “placed” when they have been submitted by advertisers to online advertising system 210 but have not yet been displayed on web pages. Thus, advertisement placement information 214 includes information relating to online advertisements that have been submitted by advertisers to online advertising system 210 but have not yet been displayed on web pages. As discussed above, online advertisements are typically targeted to an audience, which may be a general audience or may be an audience limited to geographic locations, specific age groups, genders, or other demographic groups. Advertisement placement information 214 may also include the number, type, and content of online ads placed for specific age groups, genders, or other demographic groups as well as the number of online ads placed in a particular geographic location. In some embodiments, advertisement placement information 214 is searchable, allowing supply component 206 to identify ads placed that correspond to the user-selected category of goods or services and any other information, such as geographic location, the user specifies. Advertisement placement information 214 also includes the number, type, and content of online ads placed that target a general audience.

Offline supply information 216 includes offline advertisement information and offline sales location information relating to the specified category of goods or services. Offline advertisement information includes information related to advertisements found in telephone directories, such as a “yellow pages” directory. Offline advertisement information may also include information related to offline advertisements found in local and other publications. Offline sales location information includes telephone directory listings that are not advertisements, area business listings provided by a chamber of commerce or business organization, census or survey listings, and other information sources.

Offline supply information 216 also includes online or electronic versions of telephone directories, business listings, and other information sources. These online or electronic directories may be searchable by keyword, category, geographic location, or other criterion. Online and electronic versions of telephone directories, business listings, and other offline sources are considered to be offline supply information 216 even though the information may be accessed online. In one embodiment, upon receiving a user request to determine supply, supply component 206 searches an online telephone directory and determines the number of merchants selling a particular category of goods or services in a specified geographic area.

After gathering offline supply information 216 and advertisement placement information 214 from online advertising system 210, supply component 206 applies a weighting scheme to determine supply. As with determination of demand, the weighting scheme may be selected to meet the particular preferences of the user. In some embodiments, advertisement placement information 214 is weighted most importantly, and in other embodiments, offline supply information 216 is weighted most importantly. The applied weighting scheme may include statistical formulas. Supply may be determined as a numerical value or may be determined as a relative value, such as “high.”

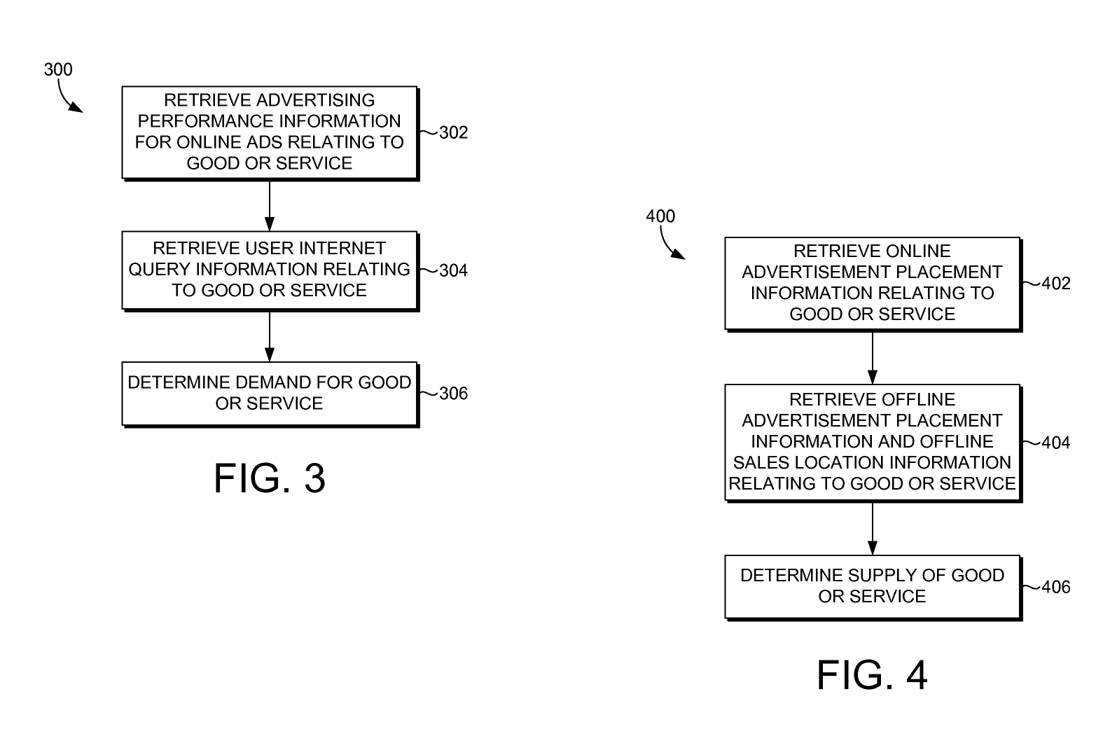

FIG. 3 illustrates a method 300 of determining demand for a category of goods or services. In some embodiments, the steps of method 300 are followed after a user has requested determination of demand and entered or selected a particular category of goods or services for which demand is to be calculated. The category may be selected from a predefined list or may be entered by the user. The user may also provide or select additional information to constrain a demand determination, such as a particular gender, age, or geographic area. Further, the user may select a particular demand result output format, such as a map or chart.

In step 302, advertising performance information for online advertisements relating to the category of goods or services is retrieved. The advertising performance information retrieved may include both ad clicks and ad conversion. In other embodiments, only one of ad click and ad conversion information is retrieved. In some embodiments, advertising performance information is only retrieved for online advertisements relating to the category of goods or services that are targeted toward a selected demographic, such as residents of a geographic location or a particular age group or gender. For example, if a user has selected to view demand for coffee among 50-year old males, advertising performance information is only retrieved for coffee-related advertisements that were displayed to 50-year old males. As discussed above, advertising performance information for an online advertisement includes metrics such as the number of times a particular online ad was displayed, the number of times a particular online ad has been clicked on by users who have viewed the ad while it was placed on a web page (“ad clicks”), and the number of times a click has resulted in a purchase (“ad conversion”).

User Internet query information relating to the category of goods or services is retrieved in step 304. User Internet query information includes the number of queries for particular keywords or phrases that relate to the category of goods or services for which demand is requested. User Internet query information may also include demographic information related to the user who performed a particular query. This demographic information may be known if the user logged in to a search system before performing the query. In some embodiments, the user Internet query information retrieved is limited to Internet queries that match a selected demographic. Continuing with the above example, if a user has selected to view demand for coffee among 50-year old males, only user Internet query information relating to Internet queries performed by 50-year old males, or queries interpreted as gifts for or performed on behalf of 50-year old males, is retrieved. In other embodiments, user Internet query information for all queries relating to the selected category of goods or services is retrieved, but queries corresponding to a selected demographic may be weighted more heavily or given preference.

In step 306, demand for the selected category of goods or services is determined. Demand is determined using a weighting scheme that considers advertising performance information and/or user Internet queries. In some embodiments, the weighting scheme considers, in order of importance, ad conversion, ad clicks, and user Internet queries. Other embodiments may only consider one or two of ad conversion, ad clicks, and user Internet queries. The applied weighting scheme may include statistical formulas. Demand may be determined as a numerical value or may be determined as a relative value, such as “high.” In some embodiments, a user selects how determined demand is presented for viewing.

FIG. 4 illustrates a method 400 for determining supply of a category of goods or services. In step 402, online advertisement placement information relating to the category of goods or services is retrieved. Online advertisement placement information includes the number of online advertisements placed on web pages for the selected category of goods or services. Online advertising placement information may be retrieved from an online advertising system and may include the number of advertisements relating to the specified category that are targeted to a specified demographic such as a particular gender or age group. A specified demographic may also include a combination of characteristics such as gender, age group, income, education, and geographic location. The retrieved online advertisement placement information may include information corresponding to related goods or services not specified by the user.

In step 404, offline supply information, such as offline advertisement placement information and offline sales location information relating to the goods or services, is retrieved. Supply of the selected category of goods or services is then determined in step 406 using a weighting scheme. As with determination of demand, the weighting scheme may be selected to meet the particular preferences of the user. In some embodiments, online advertisement placement information is weighted most importantly, and in other embodiments, offline supply information is weighted most importantly. Supply may be determined and presented as a numerical value or may be determined as a relative value, such as “high.”

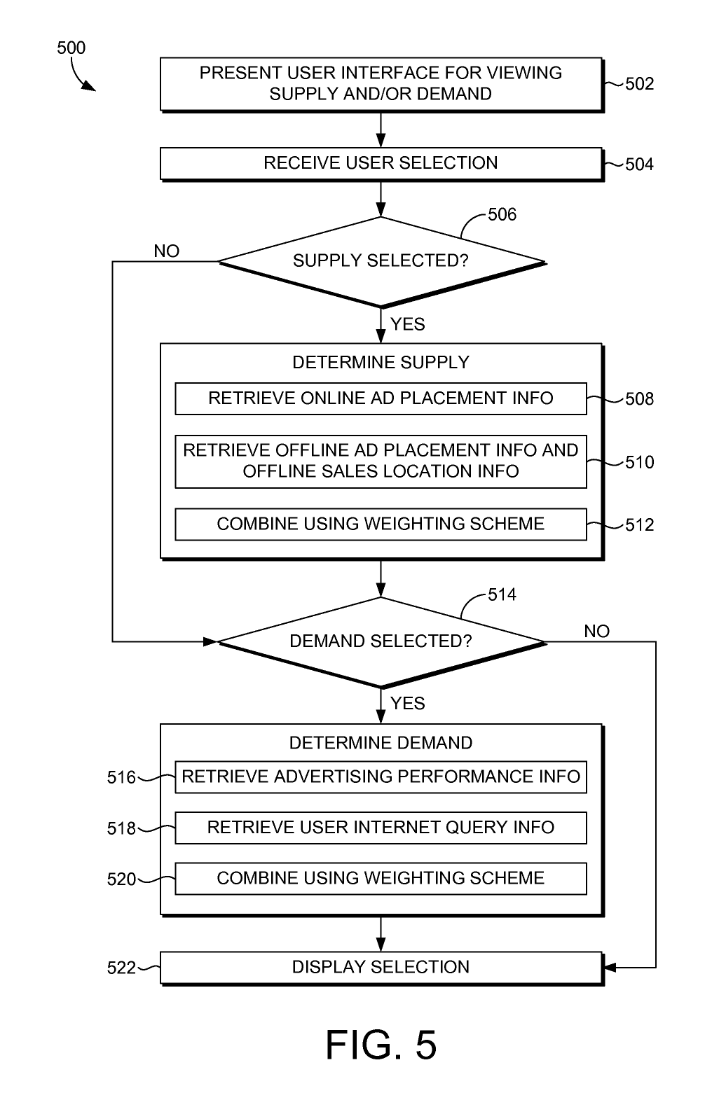

FIG. 5 illustrates a method 500 for determining supply, demand, or both supply and demand. In step 502, a user is presented with an interface for viewing supply and/or demand. A user selection specifying a category of goods or services, along with additional limiting information, is received in step 504. In step 506, it is determined if the user has selected to view supply. If the user has selected to view supply, supply is determined in steps 508-512. In step 508, online advertisement placement information is retrieved. In step 510, offline advertisement placement information and offline sales location information are retrieved. In step 512, the information retrieved in steps 508 and 510 is combined using a weighting scheme.

After supply is determined in steps 508-512, it is determined if the user selected to view demand in step 514. Steps 508-512 are omitted if it is determined in step 506 that the user did not select to determine supply. If it is determined in step 514 that the user did select to view demand, demand is determined in steps 516-520. In step 516, advertising performance information for advertisements placed on web pages relating to the selected category of goods or services is retrieved. In step 518, user Internet query information for queries relating to the selected category of goods or services is retrieved. In step 520, the retrieved information is combined using a weighting scheme. Supply and/or demand are then displayed to the user in step 522. If it is determined in step 514 that the user did not select to view demand, steps 516-520 are omitted.

Referring again to FIG. 2, as discussed above, user interface 202 allows a user to control what information is viewed. In one embodiment, user interface 202 includes an option to select supply, demand, or both supply and demand for viewing. In other embodiments, user interface 202 may present only one of supply, demand, or both supply and demand. In some embodiments, user interface 202 presents a user with options for specifying conditions and options for determining and displaying supply and/or demand.

For example, in one embodiment, the user is presented with an option to select a geographic location or area for which supply and/or demand are determined and displayed for a particular category of goods or services. Geographic selections include countries, states, counties, municipalities, addresses, postal codes, census blocks, electoral districts, and other geographic locations, extents, or areas. In other embodiments, the user may limit the display of supply of and/or demand for a category of goods or services to one or a combination of a particular gender, age group, profession, education level, income level, family status, country of origin, ethnicity, or other demographic criterion. In still further embodiments, a user may choose to view subcategories of supply and demand, whether divided into demographic subcategories or subcategories of goods and services within the category of goods or services.

User interface 200 may display supply and/or demand in a spatial format, such as a map. For example, in an embodiment where a user selects to view demand and/or supply of a category of goods or services according to zip code, a chloropleth map is presented using a color gradient such that high-demand zip codes are indicated in, for example, dark red, and low-demand zip codes are indicated in, for example, light yellow, with levels of demand between high and low indicated by colors between dark red and light yellow. Chloropleth maps using a color gradient are sometimes known as heat maps. The color scheme used to represent varying levels of demand may be selected according to the user's needs. The number of groups into which demand is classified, such as “high,” “medium,” and “low” may vary, and the determination of breaks between groups may be determined by a variety of methods, including statistical methods and user selection.

Other types of maps and other methods of data display are contemplated. In one embodiment, supply and/or demand are presented in a chart form. For example, if a user has selected to view demand for coffee in the city of Seattle by gender, user interface 202 may present demand as a pie chart indicating the portion of demand attributable to males and females. Bar graphs and other presentation formats are also contemplated.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

Having thus described the invention, what is claimed is:

1. One or more computer storage media storing computer-executable instructions for performing a method for determining demand for a category of goods or services, the method comprising:
retrieving advertising performance information for a plurality of online advertisements placed by a plurality of advertisers, the plurality of online advertisements relating to the category of goods or services;
retrieving search query information for a plurality of user Internet queries relating to the category of goods or services; and
determining demand for the category of goods or services by combining the retrieved advertising performance information and the retrieved search query information using a weighting scheme.

2. The media of claim 1, wherein advertising performance information includes ad clicks and ad conversion information.

3. The media of claim 1, wherein the weighting scheme weights purchase-related advertising performance information most heavily.

4. The media of claim 1, wherein search query information includes one of Internet Protocol address or cookie-provided information.

5. The media of claim 1, wherein the user Internet queries are categorized, and wherein the weighting scheme considers the total number of user Internet queries for each category and an Internet Protocol address for each user Internet query.

6. The media of claim 1, further comprising transmitting instructions for displaying demand for the category of goods or services according to a user-selected display preference.

7. The media of claim 6, wherein the user-selected display preference is one of gender, income, or geographic selection.

8. The media of claim 6, wherein demand is displayed spatially.

9. The media of claim 8, wherein the spatial display is a chloropleth map.

10. One or more computer storage media storing computer-executable instructions for performing a method for determining supply of a category of goods or services, the method comprising:
retrieving, for a plurality of online advertisers, online advertisement placement information relating to the category of goods or services;
retrieving, for a plurality of entities, offline advertisement placement information and offline sales location information relating to the category of goods or services; and
determining supply of the category of goods or services by combining the retrieved online and offline advertisement placement information and the offline sales location information using a weighting scheme.

11. The media of claim 10, wherein the offline advertisement placement information is retrieved from a yellow pages telephone directory.

12. The media of claim 10, wherein the offline sales location information is retrieved from a business listing.

13. The media of claim 10, wherein online advertisement placement information includes the number of advertisements in a particular category placed in a particular geographic area.

14. The media of claim 10, further comprising transmitting instructions for displaying supply of the category of goods or services according to a user-selected display preference.

15. The media of claim 14, wherein the user-selected display preference is one of gender, income, or geographic selection.

16. The media of claim 14, wherein supply is displayed spatially.

17. The media of claim 16, wherein the spatial display is a chloropleth map.

18. One or more computer storage media storing computer-executable instructions for performing a method for determining supply and demand for a category of goods or services, the method comprising:
presenting a user interface allowing a user to select and view supply, demand, or supply and demand for the category of goods or services;
upon receiving a user selection to view supply or supply and demand, determining supply by:
retrieving, for a first plurality of online advertisers, online advertisement placement information relating to the category of goods or services,
retrieving, for a plurality of entities, offline advertisement placement information and offline sales location information relating to the category of goods or services, and
combining the retrieved online and offline advertisement placement information and offline sales location information using a weighting scheme;
upon receiving a user selection to view demand or supply and demand, determining demand by:
retrieving advertising performance information for a plurality of online advertisements placed by a second plurality of advertisers, the plurality of online advertisements relating to the category of goods or services,
retrieving search query information for a plurality of user Internet queries relating to the category of goods or services, and
combining the retrieved advertising performance information and the retrieved search query information using a weighting scheme; and
displaying supply, demand, or supply and demand.

19. The media of claim 18, wherein the user selection is displayed spatially in a chloropleth map.

20. The media of claim 18, wherein the offline advertisement placement information is retrieved from a yellow pages telephone directory.
